(19) United States
(12) Patent Application Publication
(10) Pub. No.: US 2022/0128369 A1
(43) Pub. Date: Apr. 28, 2022

(54) INFORMATION PROCESSING APPARATUS, INFORMATION PROCESSING METHOD, AND NON-TRANISTORY STORAGE MEDIUM

(71) Applicant: TOYOTA JIDOSHA KABUSHIKI KAISHA, Toyota-shi Aichi-ken (JP)

(72) Inventors: Yu Nagata, Chofu-shi Tokyo-to (JP); Shin Sakurada, Toyota-shi Aichi-ken (JP); Satoshi Komamine, Nagoya-shi Aichi-ken (JP); Yusuke Sato, Nagoya-shi Aichi-ken (JP); Hiromitsu Fujii, Kariya-shi Aichi-ken (JP)

(21) Appl. No.: 17/509,387

(22) Filed: Oct. 25, 2021

(30) Foreign Application Priority Data
Oct. 27, 2020 (JP) 2020-179890

(51) Int. Cl. G01C 21/34; G01C 21/36

(52) U.S. Cl. CPC G01C 21/3438; G01C 21/3679; G01C 21/3484

(57) ABSTRACT

An information processing apparatus disclosed manages dispatch of a vehicle for a user who stays in a stay facility. The information processing apparatus includes a controller configured to obtain first information relating to an action of the user and second information relating to modes for moving of the user. When it is forecast based on the first information that the user will end staying in the stay facility, and it is determined based on the second information that an arrangement for a vehicle that the user can use has not been made beforehand, the controller sends offer information to a terminal associated with the user. The offer information is information for offering dispatch of a vehicle.

### CROSS-REFERENCE TO RELATED APPLICATIONS

This application claims the benefit of Japanese Patent Application No. 2020-179890, filed on Oct. 27, 2020, which is hereby incorporated by reference herein in its entirety.

### BACKGROUND

### Technical Field

The present disclosure relates to an information processing apparatus, an information processing method, and a non-transitory storage medium.

### Description of the Related Art

It is known in prior art to determine whether there is a possibility that a user will go to a specific destination on the basis of a record of user's location and to dispatch an autonomous vehicle to the user if it is determined that there is a possibility that the user will go to the specific destination (see, for example, Patent Literature 1 in the citation list below).

### CITATION LIST

### Patent Literature

Patent Literature 1: Japanese Translation of PCT International Application Laid-Open NO. 2019-505899

### SUMMARY

An object of this disclosure is to provide a technology that enables efficient dispatch of a vehicle to a user who will end staying in a stay facility.

Disclosed herein is an information processing apparatus for managing dispatch of a vehicle for a user staying in a stay facility. The information processing apparatus may comprise, for example, a controller including at least one processor, the controller being configured to execute the processing of:

obtaining first information, the first information being information relating an action of the user;

obtaining second information, the second information being information relating to modes for moving of the user; and

sending offer information to a terminal associated with the user, if it is forecast based on the first information that the user will end staying in the stay facility, and it is determined based on the second information that an arrangement for a vehicle that the user can use has not been made beforehand, the offer information being information for offering dispatch of a vehicle.

Also disclosed herein is an information processing method for managing dispatch of a vehicle for a user staying in a stay facility. The information processing method for managing dispatch of a vehicle for a user staying in a stay facility may comprise, for example, the following steps of processing executed by a computer:

obtaining first information, the first information being information relating an action of the user;

obtaining second information, the second information being information relating to modes for moving of the user; and

sending offer information to a terminal associated with the user, if it is forecast based on the first information that the user will end staying in the stay facility, and it is determined based on the second information that an arrangement for a vehicle that the user can use has not been made beforehand, the offer information being information for offering dispatch of a vehicle.

Also disclosed herein is an information processing program that causes a computer to implement the above-described information processing method and a non-transitory storage medium in which this information processing program is stored in a computer-readable manner.

This disclosure provides a technology that enables efficient dispatch of a vehicle to a user who will leave a stay facility.

### BRIEF DESCRIPTION OF DRAWINGS

FIG. 1 is a diagram illustrating the general configuration of a vehicle dispatch system.

FIG. 2 is a block diagram illustrating exemplary configurations of a server apparatus, a user's terminal, and a user's vehicle included in the vehicle dispatch system according to an embodiment.

FIG. 3 illustrates an exemplary message displayed on the user's terminal that has received offer information.

FIG. 4 illustrates an exemplary structure of a location information table.

FIG. 5 is a flow chart of a process executed by the server apparatus.

FIG. 6 is a block diagram illustrating exemplary configurations of a server apparatus, a user's terminal, and a user's vehicle included in a vehicle dispatch system according to a modification of the embodiment.

FIG. 7 illustrates an exemplary structure of a booking information table.

### DESCRIPTION OF EMBODIMENTS

The technology disclosed herein is characterized by forecasting that a user will end staying in a stay facility, determining whether an arrangement for a vehicle that the user can use has been made beforehand, and offering dispatch of a vehicle to the user.

Some users who will end staying in a stay facility (such as a hotel) may want to move from the stay facility by a vehicle. If an arrangement for a vehicle that such a user can use has not been made beforehand, it is necessary for the user to request dispatch of a vehicle for himself/herself or ask a clerk of the stay facility to arrange for dispatch of a vehicle. In the case where the user requests dispatch of a vehicle for himself/herself, it may be troublesome for the user to find a vehicle dispatching company or the like and request it to dispatch a vehicle. In the case where the user asks a clerk of the stay facility to arrange for dispatch of a vehicle, it may be troublesome for the user to ask the clerk for an arrangement for a vehicle or for the clerk to request a vehicle dispatch company or the like to dispatch a vehicle. Under the above circumstances, efficient dispatch of vehicles to users who leave a stay facility is desired.

An information processing apparatus disclosed herein has a controller configured to send information for offering dispatch of a vehicle (or offer information) to a terminal associated with a user, when it is forecast that the user will end staying in a stay facility and it is determined that an arrangement for a vehicle that the user can use has not been made beforehand. Specifically, the controller obtains first information and second information. The first information is information relating to an action conducted by the user, and the second information is information relating to modes for moving of the user. The controller forecasts whether the user will end staying in the stay facility on the basis of the first information. If it is forecast that the user will end staying in the stay facility, the controller determines whether an arrangement for a vehicle that the user can use has been made beforehand on the basis of the second information. If it is determined that an arrangement for a vehicle that the user can use has not been made beforehand, the controller sends offer information to a terminal associated with the user. The terminal associated with the user may be a terminal carried by the user or a terminal used by a clerk of the stay facility. If the user wants dispatch of a vehicle, the user or a clerk of the stay facility may send a response indicating acceptance of the offer presented by the offer information. When the user who will end staying in the stay facility wants dispatch of a vehicle, the above process can reduce the user's or clerk's effort of requesting dispatch of a vehicle. Even in the case where it is forecast that the user will end staying in the stay facility, if it is determined that an arrangement for a vehicle that the user can use has been made beforehand, the controller may not send offer information to the user. As above, the technology disclosed herein enables efficient dispatch of a vehicle to the user who ends staying in the stay facility.

The second information mentioned in this disclosure may include information indicating whether a vehicle that the user can use is parked in a parking lot associated with the stay facility. Such information will also be referred to as “parking information” hereinafter. The aforementioned vehicle that the user can use may be, for example, a vehicle owned by the user or a vehicle of which the user has the right of use (e.g. a rented, shared, or leased car or a company car). The aforementioned parking lot associated with the stay facility may be a parking lot managed by the stay facility (e.g. a parking lot attached to or affiliated with the stay facility) or a parking lot located within a distance from the stay facility that the user can travel on foot.

If the parking information indicates that a vehicle that the user can use is parked in a parking lot associated with the stay facility, it may be forecast that the user will move by this vehicle after the end of stay in the stay facility. Then, it may be determined that a vehicle that the user can use has been arranged beforehand as modes for moving to be used after the end of stay in the stay facility. Therefore, if the parking information indicates that a vehicle that the user can use is parked in a parking lot associated with the stay facility, the controller determines that an arrangement for a vehicle that the user can use has been made beforehand. In contrast, if the parking information indicates that a vehicle that the user can use is not parked in any parking lot associated with the stay facility, the control unit determines that an arrangement for a vehicle that the user can use has not been made beforehand. In this way, it is possible to determine whether a vehicle that the user can use has been arranged beforehand as modes for moving to be used after the end of stay in the stay facility with high accuracy.

In cases where a parking lot associated with the stay facility is a parking lot managed by the stay facility, the control unit may obtain the parking information from the stay facility. Thus, the controller can determine whether an arrangement for a vehicle that the user can use has been made beforehand on the basis of the parking information obtained from the stay facility.

The controller may obtain the parking information on the basis of location information (namely, information about the location) of a vehicle that the user can use and location information of a parking lot associated with the stay facility. Specifically, if the location of the vehicle that the user can use and the location of the parking lot associated with the stay facility coincide with each other, the controller may obtain information indicating that the vehicle that the user can use is parked in the parking lot associated with the stay facility as the parking information. In contrast, if the location of the vehicle that the user can use and the location of the parking lot associated with the stay facility do not coincide with each other, the controller may obtain information indicating that the vehicle that the user can use is not parked in the parking lot associated with the stay facility as the parking information. In consequence, the controller can determine whether an arrangement for a vehicle that the user can use has been made beforehand on the basis of the parking information obtained as above.

Whether or not a vehicle that the user can use is parked in a parking lot associated with the stay facility may be determined on the basis of the distance between the vehicle that the user can use and the stay facility. For example, this distance is small enough for the user to travel on foot, the controller may determine that a vehicle that the user can use is parked in a parking lot associated with the stay facility.

Besides the parking information, the second information mentioned in this disclosure may also include information about advance booking of a rental car or shared car by the user. Such information will also be referred to as “booking information” hereinafter. The controller may obtain the booking information from a terminal used by the user, a car rental service provider, or a car sharing service provider. For example, if booking of a rental car or a shared car is conducted by an application program installed in a terminal used by the user, the controller may obtain the booking information by communicating with the user's terminal. Alternatively, the controller may obtain the booking information by communicating with a terminal used by a car rental service provider or a car sharing service provider. The controller can determine whether the user has booked a rented car or a shared car on the basis of the booking information obtained as above.

In the case where the second information mentioned in this disclosure includes the parking information and the booking information, the controller may determine whether an arrangement for a vehicle that the user can use has been made beforehand on the basis of the parking information and the booking information. For example, if the parking information indicates that a vehicle that the user can use is not parked in any parking lot associated with the stay facility, and the booking information indicates that booking of a rented car or a shared car has not been made by the user, the controller may determine that an arrangement for a vehicle that the user can use has not been made beforehand. If the parking information indicates that a vehicle that the user can use is parked in a parking lot associated with the stay facility, or the booking information indicates that booking of a rented car or a shared car has been made by the user, the controller may determine that an arrangement for a vehicle that the user can use has been made beforehand. In this way, the controller can determine whether an arrangement for a vehicle that the user can use has been made beforehand more accurately.

The second information may include information other than the parking information and the booking information. For example, the second information may include a record of information about the locations of the user and a vehicle just before the user's checking-in at the stay facility. If the locations of the user and the vehicle just before the user's checking-in at the stay facility coincide with each other, the controller may determine that an arrangement for a vehicle that the user can use has been made beforehand. The vehicle mentioned here is a vehicle owned by the user or a vehicle of which the user has the right of use (e.g. a rented, shared, or leased car).

The first information mentioned in this disclosure may include information indicating whether the user has conducted an action that suggests checking-out from the stay facility. Examples of the action that suggests checking-out from the stay facility include paying the hotel bill, asking a clerk of the stay facility to proceed with the process for checking-out, and vacating his/her room in the stay facility. The action that suggests checking-out from the stay facility may be packing the baggage, or doing a talk that suggests checking-out from the stay facility. If the first information indicates that the user has conducted an action relating to checking-out, the controller may forecast that the user will end staying in the stay facility.

The method of forecasting whether the user will end staying in the stay facility is not limited to those described above. For example, in the case where a schedule management application program is installed in the user's terminal, the controller may communicate with the user's terminal to obtain information about the scheduled date of the end of stay in the stay facility (namely, the scheduled date of checking-out). If the scheduled date of checking-out thus obtained coincides with the present date, the controller may forecast that the user will end staying in the stay facility. If there is a record of user's stays in the stay facility in the past, the controller may statistically calculate the average time of his/her getting up on the day of ending the stay in advance, and if the difference between the statistically calculated time of getting-up and the actual time of the user's getting-up is smaller than a predetermined time, the controller may forecast that the user will end staying in the stay facility.

### Embodiment

In the following, a specific embodiment of the technology disclosed herein will be described with reference to the drawings. It should be understood that the dimensions, materials, shapes, relative arrangements, and other features of the components that will be described in connection with the embodiment are not intended to limit the technical scope of this disclosure only to them, unless otherwise stated.

What is described in the following as an embodiment is a case where the technology disclosed herein is applied to a system that provides vehicle dispatch service to users staying in a stay facility, such as a hotel. This system will also be referred to as “vehicle dispatch system” hereinafter. Vehicles dispatched by the exemplary vehicle dispatch system described in the following are vehicles for carrying passengers, such as taxis or on-demand buses. Vehicles dispatched by the vehicle dispatch service may be rented cars or shared cars.

### General Configuration of Vehicle Dispatch System

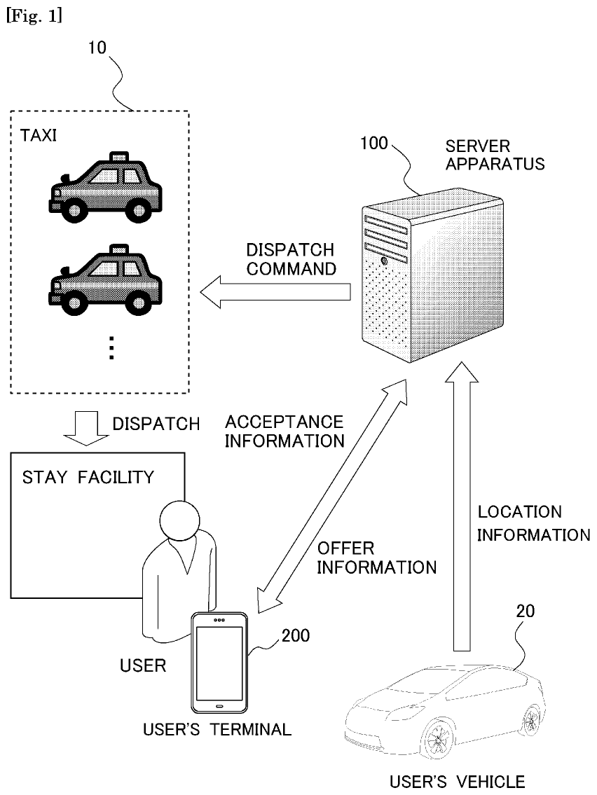

FIG. 1 is a diagram illustrating an exemplary configuration of a vehicle dispatch system that dispatches taxis to a stay facility, such as a hotel. The vehicle dispatch system illustrated in FIG. 1 includes taxis 10, a server apparatus 100, a user's vehicle 20, and a user's terminal 200.

The taxi 10 is a vehicle for carrying passengers. The server apparatus 100 is an information processing apparatus for managing dispatch of taxis 10. The user's vehicle 20 is a vehicle that a user who stays in the stay facility can use. Specifically, the user's vehicle 20 may be a vehicle owned by the user or a vehicle of which the user has the right of use (e.g. a rented, shared, or leased car or a company car). The user's vehicle 20 has the functions of determining its present location and sending information about the determined present location (or location information) to the server apparatus 100. If the user staying in the stay facility does not own a vehicle nor have the right of use of a vehicle, the user's vehicle 20 may not be included in the vehicle dispatch system. The user's terminal 200 is a portable terminal used by the user staying in the stay facility.

The server apparatus 100 in the vehicle dispatch system forecasts whether the user staying in the stay facility will end staying in the stay facility. If it is forecast that the user will end staying in the stay facility, the server apparatus 100 determines whether the user has arranged for a user's vehicle 20 beforehand on the basis of the location information of the user's vehicle 20. “That the user has arranged for a user's vehicle 20 beforehand” means that the user who will end staying in the stay facility has arranged for a user's vehicle 20 so that the user can use it as modes for moving from the stay facility. If it is determined that the user has not arranged for a user's vehicle 20 beforehand, the server apparatus 100 sends information for offering dispatch of a taxi 10 (i.e. offer information) to the user's terminal 200. If information indicating acceptance of the offer (namely, acceptance of the offer of dispatch of a taxi 10) is sent from the user's terminal 20 to the server apparatus 100 in response to the offer information, the server apparatus 100 sends a dispatch command to a taxi 10. The information indicating acceptance of the offer will also be referred to as “acceptance information” hereinafter. In this way, in the case where the user who will end staying in the stay facility has not arranged for a user's vehicle 20 beforehand, the user can request dispatch of a taxi 10 without effort. In the case where the user who will end staying in the stay facility has arranged for a user's vehicle 20 beforehand, offer information is not sent to the user's terminal 200 needlessly.

### Configuration of Vehicle Dispatch System

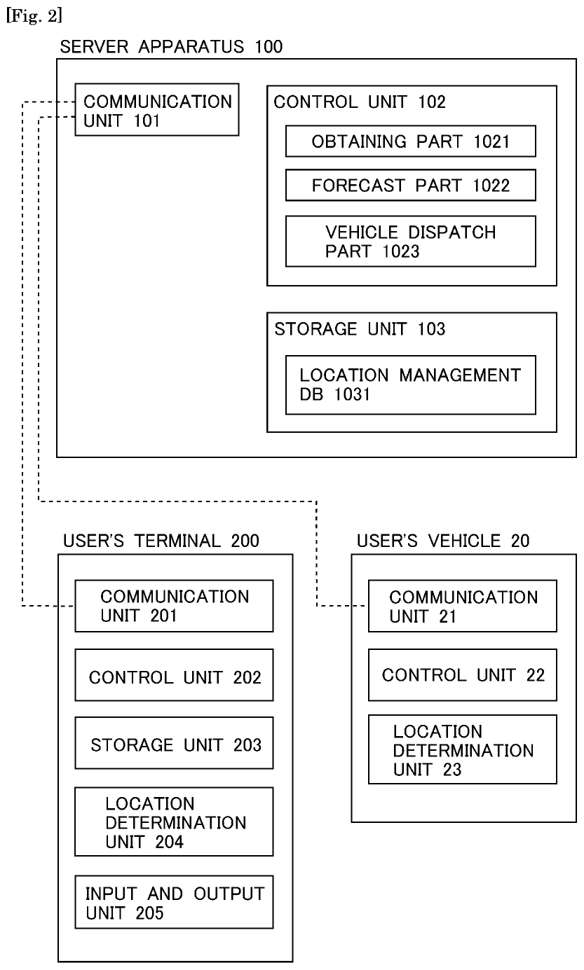

FIG. 2 is a block diagram illustrating exemplary configurations of the server apparatus 100, the user's terminal 200, and the user's vehicle 20 included in the vehicle dispatch system.

### Server Apparatus 100

The server apparatus 100 is an apparatus that manages dispatch of taxis 10. The server apparatus 100 constitutes the information processing apparatus according to this disclosure. The server apparatus 100 includes a processor, such as a CPU or a GPU, a main storage unit, such as a RAM or a ROM, and an auxiliary storage unit, such as an EPROM, a hard disk drive, or a removable medium. The removable medium may be a recording medium, such as a USB memory, a CD, or a DVD. The auxiliary storage unit stores an operating system (OS), programs, and tables. The programs stored in the auxiliary storage unit include a program used to offer dispatch of a vehicle to users who will end staying in the stay facility. The server apparatus 100 implements functions for achieving desired purposes that will be described later by executing a program(s) stored in the auxiliary storage unit by the processor. Some or all of the functions of the server apparatus 100 may be implemented by a hardware circuit(s), such as an ASIC or an FPGA.

As illustrated in FIG. 2, the server apparatus 100 of this embodiment has a communication unit 101, a control unit 102, and a storage unit 103. The configuration of the server apparatus 100 is not limited to the configuration illustrated in FIG. 2, but some components may be eliminated, added, or replaced by other components.

The communication unit 101 is a device that connects the server apparatus 100 to a network. The communication unit 101 includes a communication interface for communication with external apparatuses via the network using a communication network, such as LAN (Local Area Network), WAN (Wide Area Network), or Wi-Fi (registered trademark). The communication unit 101 may be configured to communicate with external apparatuses using a mobile communication service, such as 5G (5th Generation) mobile communications, or LTE (Long Term Evolution) mobile communications, or a wireless communication network, such as Wi-Fi.

The control unit 102 is constituted by a processor, such as a CPU, and performs overall control of the server apparatus 100. The control unit 102 of this embodiment has, as functional modules, an obtaining part 1021, a forecast part 1022, and a vehicle dispatch part 1023. The control unit 102 implements these functional modules by executing a program stored in an auxiliary storage device by the processor.

The obtaining part 1021 obtains first information and second information. The first information is information relating to an action of the user. More specifically, the first information is information indicating whether the user has conducted an action that suggests checking-out from the stay facility. Examples of the action that suggests checking-out from the stay facility include paying the hotel bill, asking a clerk of the stay facility to proceed with the process for checking-out, and vacating his/her room in the stay facility. Information about whether the user has conducted such an action may be provided to the server apparatus 100 by the stay facility. Information about whether the user has conducted an action that suggests checking-out from the stay facility may be obtained by analyzing an image captured by a surveillance camera or the like provided in the stay facility.

The action suggesting checking-out from the stay facility is not limited to the above examples, but it may be packing the baggage or doing a talk that suggests checking-out from the stay facility. Whether the user has packed the baggage may be determined based on a sensor signal of an object sensor, such as a sensor that detects an object utilizing echo location technology using ultrasonic waves or radio waves (millimeter waves), or a lock sensor that a suitcase or the like has. Whether the user has done a talk that suggests checking-out from the stay facility may be determined by analyzing voices picked up by a sound pickup device provided in the stay facility or a sound pickup device that the user's terminal 200 has.

If a schedule management application program is installed in the user's terminal 200, the obtaining part 1021 may communicate with the user's terminal 200 through the communication unit 101 to obtain information about the scheduled date of checking out as the first information. The obtaining part 1021 may obtain information about the time of user's getting-up as the first information.

The second information is information relating to modes for moving used by the user. In the case of this embodiment, the second information is parking information indicating whether a user's vehicle 20 is parked in a parking lot associated with the stay facility. The aforementioned parking lot associated with the stay facility may be, for example, a parking lot managed by the stay facility (e.g. a parking lot attached to or affiliated with the stay facility) or a parking lot located within a distance from the stay facility that the user can travel on foot. In the system of this embodiment, the second information is obtained as the aforementioned parking information, which is generated on the basis of location information of the user's vehicle 20 and location information of the parking lot associated with the stay facility. For example, the obtaining part 1021 generates the parking information by determining whether the location of the user's vehicle 20 and the location of the parking lot associated with the stay facility coincide with each other. If the location of the user's vehicle 20 and the location of the parking lot associated with the stay facility coincide with each other, the obtaining part 1021 generates information indicating that the user's vehicle 20 is parked in the parking lot associated with the stay facility as the parking information. If the location of the user's vehicle 20 and the location of the parking lot associated with the stay facility do not coincide with each other, the obtaining part 1021 generates information indicating that the user's vehicle 20 is not parked in the parking lot associated with the stay facility as the parking information. Alternatively, the obtaining part 1021 may generate the parking information by determining the distance between the location of the user's vehicle 20 and the location of the stay facility is within the range of distance over which the user can travel on foot. If the distance between the location of the user's vehicle 20 and the location of the stay facility is within the range of distance over which the user can travel on foot, the obtaining part 1021 may generate information indicating that the user's vehicle 20 is parked in the parking lot associated with the stay facility as the parking information. If the distance between the location of the user's vehicle 20 and the location of the stay facility is out of the range of distance over which the user can travel on foot, the obtaining part 1021 may generate information indicating that the user's vehicle 20 is not parked in the parking lot associated with the stay facility as the parking information. The above process of generating parking information is performed based on data stored in the storage unit 103, which will be specifically described later.

If the parking lot(s) associated with the stay facility is/are only a parking lot(s) managed by the stay facility, the stay facility may provide the parking information to the server apparatus 100.

The second information is not limited to the above-described parking information. For example, the second information may be a record of location information of the user's terminal 200 and location information of the user's vehicle 20 just before the user's checking-in at the stay facility.

The first information and the second information obtained by the obtaining part 1021 are passed from the obtaining part 1021 to the forecast part 1022.

The forecast part 1022 forecasts whether the user will end staying in the stay facility and determines whether the user has arranged for a user's vehicle 20 beforehand. The forecast as to whether the user will end staying in the stay facility is performed based on the first information. Specifically, if the first information indicates that the user has conducted an action that suggests checking-out from the stay facility, the forecast part 1022 forecasts that the user will end staying in the stay facility. If the first information indicates that the user has not conducted an action that suggests checking-out from the stay facility, the forecast part 1022 forecasts that the user will not end staying in the stay facility.

In the case where the first information is information indicating the scheduled date of user's checking-out, the forecast part 1022 may forecast whether the user will end staying in the facility by comparing the scheduled date of user's checking-out and the present date. Specifically, if the scheduled date of user's checking-out and the present date coincide with each other, the forecast part 1022 may forecast that the user will end staying in the stay facility. If the scheduled date of user's checking-out and the present date do not coincide with each other, the forecast part 1022 may forecast that the user will not end staying in the stay facility.

In the case where the first information is information indicating the time of user's getting-up, the forecast part 1022 may forecast whether the user will end staying in the stay facility by comparing the time of user's getting-up and a statistical value. Specifically, if the difference between the time of user's getting-up and the statistical value is not larger than a first predetermined length of time (e.g. several minutes to one hour), the forecast part 1022 may forecast that the user will end staying in the stay facility. If the difference between the time of user's getting-up and the statistical value is larger than the first predetermined length of time, the forecast part 1022 may forecast that the user will not end staying in the stay facility. The statistical value mentioned above is a value calculated statistically for the user who has a record of stays in the stay facility in the past as the average time of his/her getting-up on the day of the end of his/her stay in the stay facility.

The determination as to whether the user has arranged for a user's vehicle 20 beforehand is performed based on the second information. Specifically, if the second information indicates that the user's vehicle 20 is not parked in a parking lot associated with the stay facility, the forecast part 1022 determines that the user has not arranged for a user's vehicle 20 beforehand. If the second information indicates that the user's vehicle 20 is parked in a parking lot associated with the stay facility, the forecast part 1022 determines that the user has arranged for a user's vehicle 20 beforehand.

In the case where the second information is a record of location information of the user's terminal 200 and location information of the user's vehicle 20 just before the user's checking-in at the stay facility, the forecast part 1022 may forecast whether the user has arranged for a user's vehicle 20 beforehand on the basis of this record. Specifically, if the location of the user's terminal 200 and the location of the user's vehicle 20 in this record coincide with each other, the forecast part 1022 may determine that the user has arranged for a user's vehicle 20 beforehand. If the location of the user's terminal 200 and the location of the user's vehicle 20 in this record do not coincide with each other, the forecast part 1022 may determine that the user has not arranged for a user's vehicle 20 beforehand.

The result of forecast by the forecast part 1022 is passed from the forecast part 1022 to the vehicle dispatch part 1023.

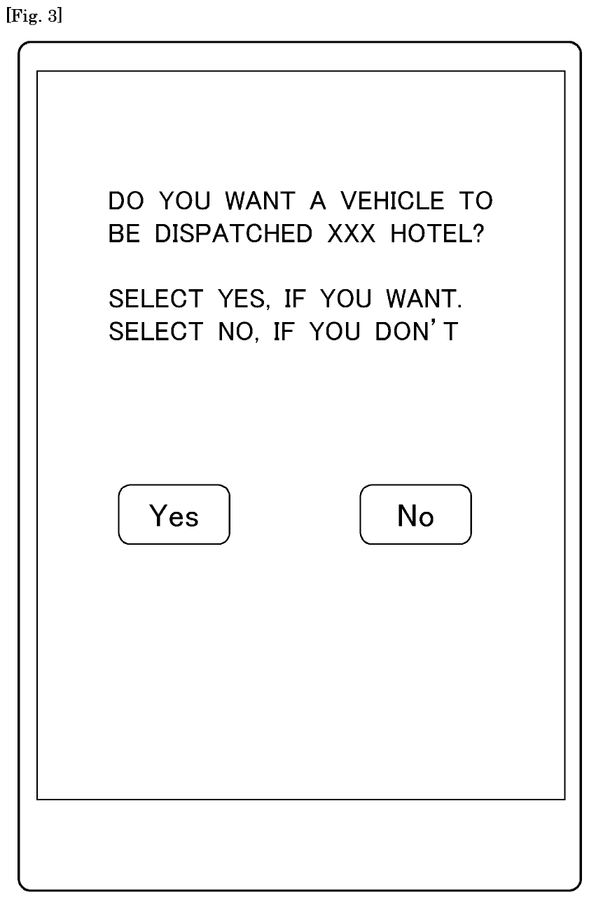

The vehicle dispatch part 1023 has the functions of generating offer information and dispatching a taxi 10. Specifically, if it is forecast that the user will end staying in the stay facility, and the user has not arranged for a user's vehicle 20 beforehand, the vehicle dispatch part 1023 generates offer information. The offer information is information for offering dispatch of a taxi 10 to the stay facility for the user who is forecast to end staying in the stay facility. For example, the offer information includes information for causing the user's terminal 200 to display a screen shown in FIG. 3. The offer information is sent from the vehicle dispatch part 1023 to the user's terminal 200 through the communication unit 101. If the user sees the screen shown in FIG. 3 and selects “Yes”, the user's terminal 200 sends acceptance information to the server apparatus 100. The acceptance information is information indicating the user's acceptance of the offer presented by the offer information (namely, offer of dispatch of a taxi 10 to the stay facility). If the user sees the screen shown in FIG. 3 and selects “No”, the user's terminal 200 does not send acceptance information to the server apparatus 100. If the communication unit 101 of the server apparatus 100 receives the acceptance information, the vehicle dispatch part 1023 selects a taxi 10 to be dispatched from among empty taxis 10 and sends a dispatch command to the selected taxi 10. The dispatch command is a command that causes the taxi 10 to go to the stay facility to pick up the user.

The storage unit 103 is constituted by the main storage unit and/or the auxiliary storage unit. The storage unit 103 stores various information. Specifically, the storage unit 103 stores various programs executed by the processor and various data. In the storage unit 103 of this embodiment is constructed a location management database 1031. The location management databases 1031 is constructed by managing data stored in the auxiliary storage unit by a database management system program (DBMS program) executed by the processor. The location management database 1031 may be a relational database.

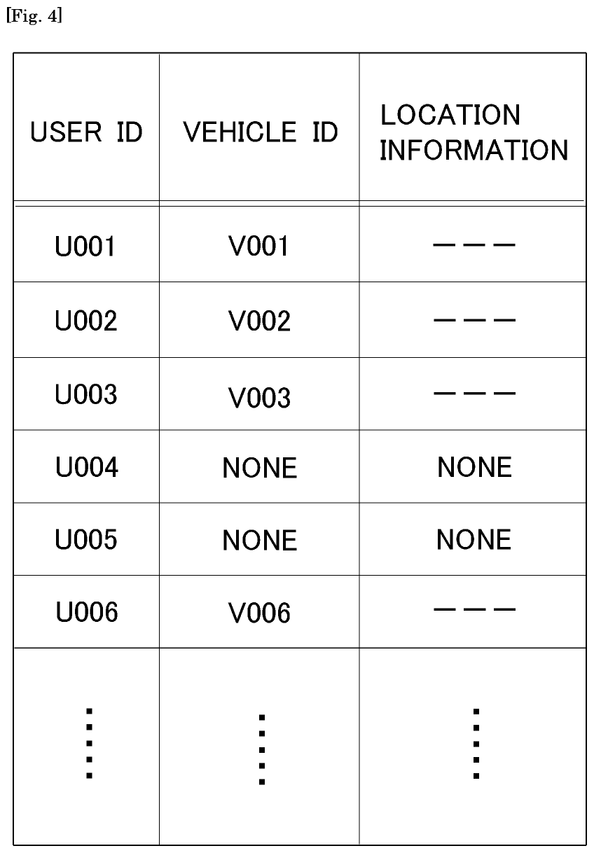

What is stored in the location management database 1031 is location information of the user's vehicle 20. The location management database 1031 links each user who stays in the stay facility and the location of his/her vehicle 20 (i.e. user's vehicle 20) with each other. An exemplary structure of information stored in the location management database 1031 will be described here with reference to FIG. 4. FIG. 4 illustrates an exemplary table structure of information stored in the location management database 1031. As illustrated in FIG. 4, tables stored in the location management database 1031 (which will also be referred to as location information tables) are created for respective users staying in the stay facility. In other words, location information tables as many as the users staying in the stay facility are stored in the location management database 1031. Each location information table has the fields of user ID, vehicle ID, and location information. What is stored in the user ID field is information (or a user ID) for identifying each of the users staying in the stay facility. The user ID is information for discriminating each user from the other users staying in the stay facility. The user ID does not need to contain personal information of each user. In the case where a group of users stays in the stay facility, the user ID of the representative user of the group may be stored in the user ID field. What is stored in the vehicle ID field is information for identifying each of vehicles (or user's vehicles 20) of which respective users staying in the stay facility have the ownership or the right of use. What is stored in the location information field is location information indicating the present location of each user's vehicle 20. The information stored in the location information field is updated every time the server apparatus 100 receives location information sent from the user's vehicle 20. In the case of users who do not have the ownership or the right of use of a vehicle, the information “none” is stored in the vehicle ID field and the location information field associated with them.

The location information table for each user is created when the user checks in at the stay facility and may be deleted when the user checks out from the stay facility.

Various processing executed by the server apparatus 100 configured as above may be executed by either hardware or software. The configuration of the server apparatus 100 is not limited to the configuration illustrated in FIG. 2, but some components may be eliminated, added, or replaced by other components.

### User's Terminal 200

The user's terminal 200 is a small computer carried by the user who stays in the stay facility. The user's terminal 200 may be, for example, a smartphone, a cellular phone, a tablet terminal, or a wearable computer (e.g. a smartwatch).

As illustrated in FIG. 2, the user's terminal 200 has a communication unit 201, a control unit 202, a storage unit 203, a location determination unit 204, and input and output unit 205. The configuration of the user's terminal 200 is not limited to the configuration illustrated in FIG. 2, but some components may be eliminated, added, or replaced by other components.

The communication unit 201 is a wireless communication interface for connecting the user's terminal 200 to a network. The communication unit 201 is connected to a network using a mobile communication service, such as 5G (5th Generation) mobile communications, or LTE (Long Term Evolution) mobile communications, or a wireless communication network, such as Wi-Fi (registered trademark) and communicates with the server apparatus 100 through the network.

The control unit 202 is constituted by, for example, a microcomputer and performs overall control of the user's terminal 200. For example, the control unit 202 controls the location determination unit 204 (which will be specifically described later) to determine the present location of the user's terminal 200. The control unit 202 sends location information indicating the present location determined by the location determination unit 204 to the server apparatus 100 through the communication unit 201. The user's terminal 200 executes the processing of determining the present location and sending the location information in response to a request sent from the server apparatus 100. When the communication unit 201 receives the offer information from the server apparatus 100, the control unit 202 causes the input and output unit 205 (which will be described later) to display the screen shown in FIG. 3. When the user selects “Yes” on the screen shown in FIG. 3, the control unit 202 sends the acceptance information to the server apparatus 100 through the communication unit 201.

The storage unit 203 stores various information. The storage unit 203 may be constituted by a storage medium, such as a RAM, a magnetic disk, or a flash memory. The storage unit 203 stores various programs executed by the control unit 202 and various data.

The location determination unit 204 is a device that determines the present location of the user's terminal 200. The location determination unit 204 typically includes a GPS (Global Positioning System) receiver.

The input and output unit 205 is configured to receive inputting operations conducted by the user and present information to the user. The input and output unit 205 includes, for example, a touch panel, a control circuit for the touch panel, a liquid crystal display, a control circuit for the liquid crystal display, a microphone, a control circuit for the microphone, a speaker, and a control circuit for the speaker. The touch panel and the liquid crystal display may be constituted by a single touch panel display. When the user's terminal 200 receives the offer information sent from the server apparatus 100, the input and output unit 205 outputs the screen shown in FIG. 3 on the touch panel display. When the user selects “Yes” or “No” in the screen shown in FIG. 3 on the touch panel display, the input and output unit 205 passes information about the result of selection to the control unit 202.

Various processing executed by the user's terminal 200 configured as above may be executed by either hardware or software.

### User's Vehicle 20

The user's vehicle 20 is a vehicle of which the user staying in the stay facility has the ownership or the right of use. As illustrated in FIG. 2, the user's vehicle 20 has a communication unit 21, a control unit 22, and a location determination unit 23. Besides the above components, the user's vehicle 20 also has devices for the travel of the user's vehicle 20, such as a motor, a change gear, a steering device, a brake device, and an ECU (Electronic Control Unit) for controlling these devices, though not illustrated in FIG. 2.

The communication unit 21, the control unit 22, and the location determination unit 23 of the user's vehicle 20 are similar to the communication unit 201, the control unit 202, and the location determination unit 204 of the user's terminal 200 and will not described further.

### Process Performed by Server Apparatus

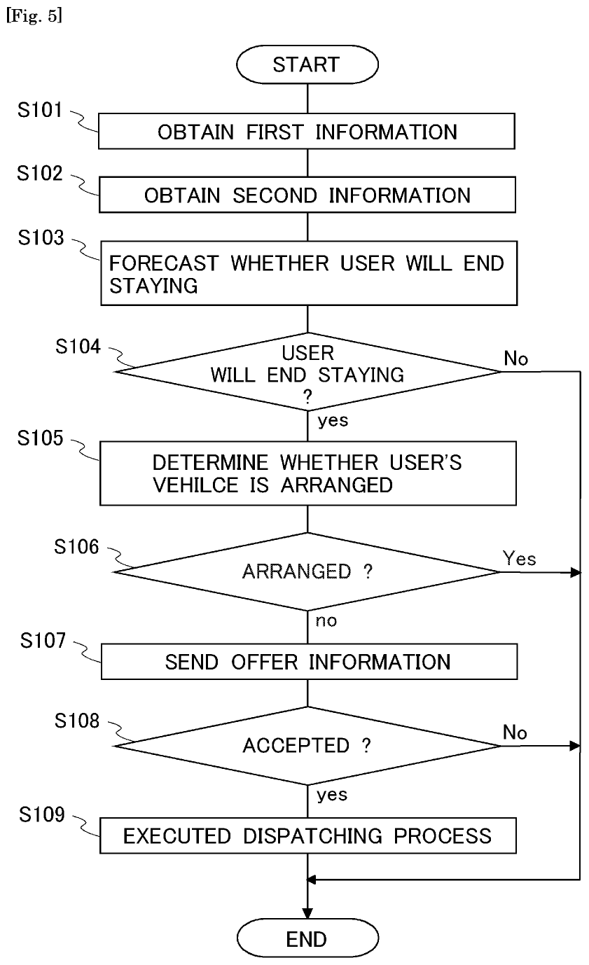

A process performed by the server apparatus 100 of this embodiment will now be described with reference to FIG. 5. FIG. 5 is a flow chart of a process executed repeatedly by the server apparatus 100 at predetermined intervals. The process according to the flow chart of FIG. 5 is executed for every user who stays in the stay facility individually.

In the process according to the flow chart of FIG. 5, the obtaining part 1021 of the server apparatus 100 obtains the first information (step S101). As described above, the first information according to this embodiment is information indicating whether the user staying in the stay facility has conducted an action that suggests checking-out from the stay facility. The first information is supplied to the server apparatus 100 by the stay facility. To invite the stay facility to supply the first information to the server apparatus 100, the obtaining part 1021 may send a request for supply of the first information to a terminal in the stay facility through the communication unit 101.

In step S102, the obtaining part 1021 obtains the second information. As described above, the second information according to the second embodiment includes information indicating whether the user's vehicle 20 is parked in the parking lot associated with the stay facility (i.e. parking information). The parking information is generated based on the location information of the user's vehicle 20 and the location information of the parking lot associated with the stay facility. More specifically, the obtaining part 1021 accesses the location management database 1031 using the user ID of the user as an argument to find the location information table associated with the user. Then, the obtaining part 1021 retrieves the information stored in the location information field of the location information table found as above (i.e. the location information of the user's vehicle 20). Then, the obtaining part 1021 compares the location information of the user's vehicle 20 and the location information of the parking lot associated with the stay facility. If the location of the user's vehicle 20 and the location of the parking lot associated with the stay facility coincide with each other, the obtaining part 1021 generates information indicating that the user's vehicle 20 is parked in the parking lot associated with the stay facility as the parking information. If the location of the user's vehicle 20 and the location of the parking lot associated with the stay facility do not coincide with each other, the obtaining part 1021 generates information indicating that the user's vehicle 20 is not parked in the parking lot associated with the stay facility as the parking information. In the case where the information “none” is stored in the location information field of the location information table, the obtaining part 1021 generates information indicating that the user's vehicle 20 is not parked in the parking lot associated with the stay facility as the parking information. The second information is obtained by generating the parking information in the above described way.

The first information and the second information obtained in steps S101 and S102 are passed from the obtaining part 1021 to the forecast part 1022. Either of the processing of step S101 and the processing of step S102 may be executed earlier than the other. The processing of step S101 and the processing of step S102 may be executed concurrently.

In step S103, the forecast part 1022 forecasts whether the user will end staying in the stay facility. The forecast in step S103 is executed based on the first information. If the first information indicates that the user has conducted an action that suggests checking-out from the stay facility, the forecast part 1022 forecasts that the user will end staying in the stay facility. If the first information indicates that the user has not conducted an action that suggests checking-out from the stay facility, the forecast part 1022 forecasts that the user will not end staying in the stay facility.

In step S104, a determination based on the result of forecast in step S103 is made. Specifically, a determination is made as to whether it was forecast in step S103 that the user will end staying in the stay facility. If it is forecast in step S103 that the user will not end staying in the stay facility, step S104 is answered in the negative. Then, the process is ended. If it was forecast in step S103 that the user will end staying in the stay facility, step S104 is answered in the affirmative. Then, the processing of step S105 is executed next.

In step S105, the forecast part 1022 determines whether the user has arranged for the user's vehicle 20 beforehand. The determination in step S105 is made based on the second information. Specifically, if the parking information included in the second information indicates that the user's vehicle 20 is parked in the parking lot associated with the stay facility, the forecast part 1022 determines that the user has arranged for the user's vehicle 20 beforehand. If the second information indicates that the user's vehicle 20 is not parked in the parking lot associated with the stay facility, the forecast part 1022 determines that the user has not arranged for the user's vehicle 20 beforehand. The result of determination in step S105 is passed to the vehicle dispatch part 1023.

In step S106, the vehicle dispatch part 1023 determines that whether it is determined in step S105 that the user has arranged for the user's vehicle 20 beforehand. If it is determined in step S105 that the user has arranged for the user's vehicle 20 beforehand, step S106 is answered in the affirmative. Then, this process is ended. If it is determined in step S105 that the user has not arranged for the user's vehicle 20 beforehand, step S106 is answered in the negative. Then, the processing of step S107 is executed next.

In step S107, the vehicle dispatch part 1023 sends offer information to the user's terminal 200. Specifically, the vehicle dispatch part 1023 creates information (or offer information) for offering dispatch of a taxi 10 to the stay facility. As described above, the offer information is information for causing the user's terminal to display the screen shown in FIG. 3. The offer information created by the vehicle dispatch part 1023 is sent to the user's terminal 200 through the communication unit 101.

In step S108, the vehicle dispatch part 1023 determines whether the communication unit 101 has received acceptance information from the user's terminal 200. The acceptance information is information indicating the user's acceptance of the offer presented by the offer information (namely, offer of dispatch of a taxi 10 to the stay facility). The acceptance information is created by the user's operation of selecting “Yes” in the screen shown in FIG. 3 displayed on the user's terminal 200 and sent from the user's terminal 200 to the server apparatus 100. Even if the user intends to accept the offer by the offer information, the acceptance information is not always sent back immediately. In view of this, in step S108, the vehicle dispatch part 1023 may determine whether the communication unit 101 receives the acceptance information within a second predetermined length of time (e.g. several or several tens of minutes) from the time of sending the offer information. If the communication unit 101 does not receive the acceptance information from the user's terminal 200 within the second predetermined length of time from the time of sending the offer information (a negative answer in step S108), this process is ended. If the communication unit 101 receives the acceptance information from the user's terminal 200 within the second predetermined length of time from the time of sending the offer information (an affirmative answer in step S108), the processing of step S109 is executed next.

In step S109, the vehicle dispatch part 1023 executes the processing of dispatching a vehicle. Specifically, the vehicle dispatch part 1023 selects a taxi 10 to be dispatched from among empty taxis 10 and sends a dispatch command to the selected taxi 10. As described above, the dispatch command is a command for causing the taxi 10 to go to the stay facility to pick up the user.

The above-described system according to the embodiment can offer dispatch of a taxi 10 to the user who will end staying in the stay facility, if the user has not arranged for the user's vehicle 20 beforehand. If the user wants dispatch of a taxi 10, he or she can request it without effort. In the case where the user who will end staying in the stay facility has arranged for the user's vehicle 20 beforehand, the system may be prevented from offering dispatch of a taxi 10 for the user. Thus, the system can dispatch a vehicle efficiently for users who will end staying in the stay facility.

### Modification

While in the system according to the embodiment the parking information is used as the second information, the second information may include the parking information and booking information. The booking information is information about advance booking of a rented or shared car (which will be simply referred to as “rented car” hereinafter).

Some users who stay in the stay facility may travel by a car they rent after checking out from the stay facility. In the case of such users, the parking information has to be information indicating that the user's vehicle 20 is not parked in the parking lot associated with the stay facility. If the second information includes only the parking information, the offer information may be sent to such users.

To avoid this, the system may be modified to include booking information in the second information in addition to the parking information and determine whether the user has arranged for a user's vehicle 20 beforehand on the basis of the parking information and the booking information.

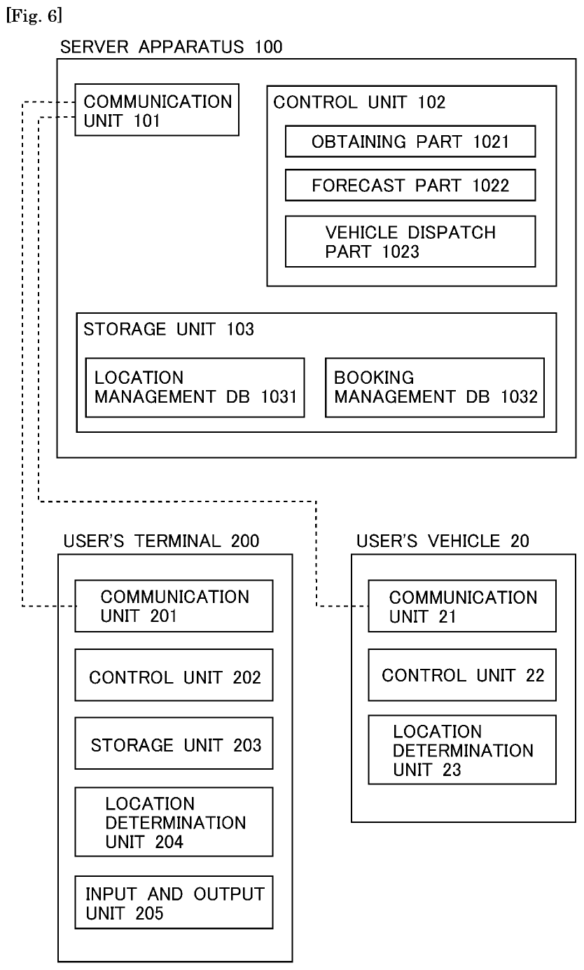

FIG. 6 is a block diagram illustrating exemplary configurations of the server apparatus 100, the user's terminal 200, and the user's vehicle 20 included in the vehicle dispatch system according to the modification. In FIG. 6, the components same as those in the system according to the above embodiment are denoted by the same reference signs as in FIG. 2.

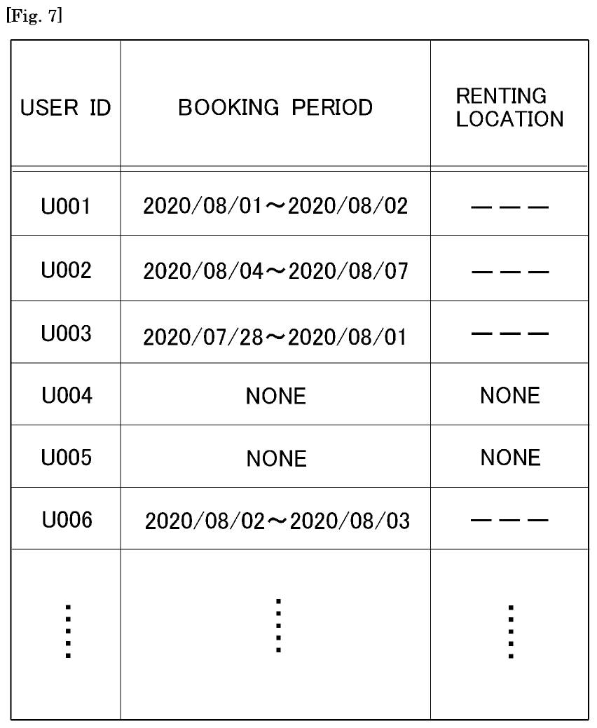

As illustrated in FIG. 6, a booking management database 1032 is constructed in the storage unit 103 of the server apparatus 100 of this modification in addition to the location management database 1031. What is stored in the booking management database 1032 is information relating to booking of a rented car. The booking management database 1032 links each user who stays in the stay facility and information about his/her booking of a rented car with each other. An exemplary structure of information stored in the booking management database 1032 will be described with reference to FIG. 7. FIG. 7 illustrates an exemplary table structure of information stored in the booking management database 1032. As illustrated in FIG. 7, tables stored in the booking management database 1032 (which will also be referred to as booking information tables) are created for respective users staying in the stay facility. In other words, booking information tables as many as the users staying in the stay facility are stored in the booking management database 1032. Each booking information table has the fields of user ID, booked period, and rental location. What is stored in the user ID field is information (or a user ID) for identifying each of the users staying in the stay facility. The user ID stored in this field is the same as the information stored in the user ID field of the location information table. In the case where a group of users stays in the stay facility, the user ID of the representative user of the group may be stored in the user ID field. What is stored in the booked period field is information indicating the period through which rental of a car to the user staying in the stay facility is booked (namely, the period through which a car will be rented to the user). What is stored in the renting location field is information about a location at which renting of a car to the user staying in the stay facility will be started. In the case of the users who have not booked a rented car, the information “none” is stored in the booked period field and the renting location field associated with them.

A booking information table associated with each user is created when the user checks in at the stay facility and may be deleted when the user checks out from the stay facility. The information stored in the booked period field and the renting location field of the booking information table may be supplied to the server apparatus 100 by the car rental service provider. In cases where booking of a rented car is performed by an application program installed in the user's terminal 200, the server apparatus 100 may communicate with the user's terminal 200 to obtain information about the booked period and information about the location at which rental of a car will be started.

The obtaining part 1021 of this modification creates booking information of each user staying in the stay facility by accessing the booking management database 1032. Specifically, the obtaining part 1021 accesses the booking information table associated with the user to retrieve the information stored in the booked period field (i.e. information about the period of car rental) and the information stored in the renting location field (i.e. information about the location at which car rental will be started). If the date of the beginning of the period of car rental specified by the retrieved information coincides with the present date, and the location at which car rental will be started specified by the retrieved information is near the stay facility (or within a predetermined distance from the stay facility), the obtaining part 1021 generates information indicating that the user has booked a rented car as the booking information. If the date of the beginning of the period of car rental specified by the retrieved information does not coincide with the present date, or the location at which car rental will be started specified by the retrieved information is not near the stay facility, the obtaining part 1021 generates information indicating that the user has not booked a rented car as the booking information. In the case where the information “none” is stored in the booked period field and the renting location field of the booking information table, the obtaining part 1021 generates information indicating that the user has not booked a rented car as the booking information.

The forecast part 1022 of this modification determines whether the user has arranged for a user's vehicle 20 beforehand on the basis of the parking information and the booking information generated by the obtaining part 1021. Specifically, if the parking information indicates that the user's vehicle 20 is not parked in the parking lot associated with the stay facility, and the booking information indicates that the user has not booked a rented car, the forecast part 1022 determines that the user has not arranged for a user's vehicle 20 beforehand. If the parking information indicates that the user's vehicle 20 is parked in the parking lot associated with the stay facility, or the booking information indicates that the user has booked a rented car, the forecast part 1022 determines that the user has arranged for a user's vehicle 20 beforehand.

The configurations and the functions of the components of the system of this modification other than the booking management database 1032, the obtaining part 1021, and the forecast part 1022 are the same as those of the system according to the above embodiment.

The system of this modification is prevented from unnecessarily sending offer information to users who are scheduled to rent a car after checking out from the stay facility as well as users who have parked a user's vehicle 20 in the parking lot associated with the stay facility. Thus, the system can dispatch a vehicle more efficiently for users who will end staying in the stay facility.

### Others

The above embodiment and modifications have been described only by way of example. Modifications can be made to them without departing from the essence of this disclosure. Features of the systems according to the above-described embodiment and modification may be employed in any possible combination.

The processing that have been described in this disclosure may be employed in any combination so long as it is technically feasible to do so. One, some, or all of the processes that have been described as processes performed by one apparatus may be performed by a plurality of apparatuses in a distributed manner. One, some, or all of the processes that have been described as processes performed by different apparatuses may be performed by a single apparatus. The hardware configuration employed to implement various functions in a computer system may be modified flexibly.

The technology disclosed herein can be carried out by supplying a computer program(s) (i.e. information processing program) that implements the functions described in the above description of the embodiment to a computer to cause one or more processors of the computer to read and execute the program(s). Such a computer program(s) may be supplied to the computer by a computer-readable, non-transitory storage medium that can be connected to a system bus of the computer, or through a network. The computer-readable, non-transitory storage medium refers to a recording medium that can store information, such as data and programs, electrically, magnetically, optically, mechanically, or chemically in such a way as to allow the computer or the like to read the stored information. Examples of such a non-transitory, computer-readable recording medium include any type of discs including magnetic discs, such as a floppy disc (registered trademark) and a hard disk drive (HDD), and optical discs, such as a CD-ROM, a DVD, and a Blu-ray disc. The computer-readable, non-transitory storage medium may include other storage media, such as a read-only memory (ROM), a random access memory (RAM), an EPROM, an EEPROM, a magnetic card, a flash memory, an optical card, and a solid state drive (SSD).

What is claimed is:

1. An information processing apparatus for managing dispatch of a vehicle for a user staying in a stay facility, comprising a controller including at least one processor, the controller being configured to execute the processing of;
obtaining first information, the first information being information relating an action of the user;
obtaining second information, the second information being information relating to modes for moving of the user; and
sending offer information to a terminal associated with the user, when it is forecast based on the first information that the user will end staying in the stay facility, and it is determined based on the second information that an arrangement for a vehicle that the user can use has not been made beforehand, the offer information being information for offering dispatch of a vehicle.

2. The information processing apparatus according to claim 1, wherein the second information comprises information indicating whether a vehicle that the user can use is parked in a parking lot associated with the stay facility.

3. The information processing apparatus according to claim 2, wherein the parking lot associated with the stay facility is a parking lot managed by the stay facility, and the controller obtains the second information from the stay facility.

4. The information processing apparatus according to claim 2, wherein the controller obtains the second information on the basis of location information of the vehicle that the user can use and location information of the parking lot associated with the stay facility.

5. The information processing apparatus according to claim 2, wherein when the second information indicates that a vehicle that the user can use is not parked in a parking lot associated with the stay facility, the controller determines that an arrangement for a vehicle that the user can use has not been made beforehand.

6. The information processing apparatus according to claim 2, wherein the second information further comprises information relating to booking of a rented car or a shared car by the user, and the controller obtains the second information from a terminal used by the user, a car rental service provider, or a car sharing service provider.

7. The information processing apparatus according to claim 6, wherein when the second information indicates that a vehicle that the user can use is not parked in a parking lot associated with the stay facility and that the user has not booked a rented car or a shared car, the controller determines that an arrangement for a vehicle that the user can use has not been made beforehand.

8. The information processing apparatus according to claim 1, wherein the first information comprises information indicating whether the user has conducted an action that suggests checking-out from the stay facility.

9. The information processing apparatus according to claim 8, wherein when the first information indicates that the user has conducted an action that suggests checking-out from the stay facility, the controller forecasts that the user will end staying in the stay facility.

10. The information processing apparatus according to claim 8, wherein the action that suggests checking-out from the stay facility is packing of the baggage conducted by the user.

11. The information processing apparatus according to claim 8, wherein the action that suggests checking-out from the stay facility is doing a talk that suggests checking-out from the stay facility.

12. An information processing method for managing dispatch of a vehicle for a user staying in a stay facility, comprising the following steps of processing executed by a computer:
obtaining first information, the first information being information relating an action of the user;
obtaining second information, the second information being information relating to modes for moving of the user; and
sending offer information to a terminal associated with the user, when it is forecast based on the first information that the user will end staying in the stay facility, and it is determined based on the second information that an arrangement for a vehicle that the user can use has not been made beforehand, the offer information being information for offering dispatch of a vehicle.

13. The information processing method according to claim 12, wherein the second information comprises information indicating whether a vehicle that the user can use is parked in a parking lot associated with the stay facility.

14. The information processing method according to claim 13, wherein the parking lot associated with the stay facility is a parking lot managed by the stay facility, and the computer obtains the second information from the stay facility.

15. The information processing method according to claim 13, wherein the computer obtains the second information on the basis of location information of the vehicle that the user can use and location information of the parking lot associated with the stay facility.

16. The information processing method according to claim 13, wherein when the second information indicates that a vehicle that the user can use is not parked in a parking lot associated with the stay facility, the computer determines that an arrangement for a vehicle that the user can use has not been made beforehand.

17. The information processing method according to claim 13, wherein the second information further comprises information relating to booking of a rented car or a shared car by the user, and the computer obtains the second information from a terminal used by the user, a car rental service provider, or a car sharing service provider.

18. The information processing method according to claim 17, wherein when the second information indicates that a vehicle that the user can use is not parked in a parking lot associated with the stay facility and that the user has not booked a rented car or a shared car, the computer determines that an arrangement for a vehicle that the user can use has not been made beforehand.

19. The information processing method according to claim 12, wherein the first information comprises information indicating whether the user has conducted an action that suggests checking-out from the stay facility.

20. A non-transitory storage medium storing an information processing program for managing dispatch of a vehicle for a user staying in a stay facility, the information processing program being configured to cause a computer to execute the following steps of processing;
obtaining first information, the first information being information relating an action of the user;
obtaining second information, the second information being information relating to modes for moving of the user; and
sending offer information to a terminal associated with the user, when it is forecast based on the first information that the user will end staying in the stay facility, and it is determined based on the second information that an arrangement for a vehicle that the user can use has not been made beforehand, the offer information being information for offering dispatch of a vehicle.
